(19) United States
(12) Patent Application Publication
(10) Pub. No.: US 2017/0188009 A1
(43) Pub. Date: Jun. 29, 2017

(54) Method for optimizing playback of stereoscopic film source and apparatus

(71) Applicants: Le Holdings (Beijing) Co., Ltd., Beijing (CN); Le Shi Zhi Xin Electronic Technology (Tianjin) Limited, Tianjin (CN)

(72) Inventors: Shanghui Zhang, Binhai New Area (CN); Minglei Chu, Binhai New Area (CN)

(21) Appl. No.: 15/241,196

(22) Filed: Aug. 19, 2016

Related U.S. Application Data
(63) Continuation of application No. PCT/CN2016/089565, filed on Jul. 10, 2016.

(30) Foreign Application Priority Data
Dec. 28, 2015 (CN) 201511014472.3

(51) Int. Cl. H04N 13/00; H04N 5/84; H04N 9/89; G11B 27/10

(52) U.S. Cl. CPC H04N 13/0055; H04N 13/0018; H04N 13/0022; G11B 27/10; H04N 5/846; H04N 9/89

(57) ABSTRACT

Embodiments of the present disclosure relate to the field of multimedia technology, and discloses a method and electronic device for optimizing playback of a stereoscopic film source and an apparatus. Some embodiments of the present disclosure include the following steps: acquiring a stereoscopic adjustment parameter related to a timeline of a stereoscopic film source, wherein the stereoscopic adjustment parameter includes T offset adjustments and time periods corresponding to the T offset adjustments, wherein T is a natural number; and when the stereoscopic film source is played in a stereoscopic mode, adjusting an offset of a frame that is in the time period, wherein the adjusted offset is the offset adjustment corresponding to the time period.

### CROSS-REFERENCE TO RELATED APPLICATIONS

This disclosure is a continuation of PCT application No. PCT/CN2016/089565 submitted on Jul. 10, 2016, and claims priority to Chinese Patent Application No. 201511014472.3, filed on Dec. 28, 2015 and entitled “METHOD AND ELECTRONIC DEVICE FOR OPTIMIZING PLAYBACK OF STEREOSCOPIC FILM SOURCE,” the entire contents of which are incorporated herein by reference.

### TECHNICAL FIELD

The present invention relates to the field of multimedia technology, and more particularly, to a method and electronic device for optimizing playback of a stereoscopic film source.

### BACKGROUND

With the development of 3D display technology, application of stereoscopic display also becomes increasingly wider. However, for a same stereoscopic film source, such as a film, the stereoscopic display effect varies on different display devices. In the process of watching, factors affecting a stereoscopic effect mainly include a display size of a stereoscopic film, that is, a size of a display screen, parallax of the stereoscopic film, and the like.

In the process of implementing the present invention, the inventors have found that stereoscopic films are generally films suitable for watching in a cinema. When the films are played on other devices, such as a Virtual Reality (VR) device, the whole effect will change. That is, a stereoscopic film having a best playback effect in a cinema may not have a best effect on a VR device. Therefore, to achieve a relatively good stereoscopic effect, adjustment needs to be made to the stereoscopic film. A conventional adjustment method is to provide a universal parameter to a film, so that the film is played according to the parameter during playback. However, different parameters are needed by different scenes to achieve optimal stereoscopic effects. Uniformly adjusting all scenes by using a same parameter will result in that some scenes look good, but most of the scenes do not have ideal effects.

### SUMMARY

The present disclosure provides a method and electronic device for optimizing playback of a stereoscopic film source. By using a timeline of a stereoscopic film source as a main line, suitable offset adjustments are configured for frames of all time periods to achieve required stereoscopic effects, so as to ensure matching of all stereoscopic parameters used in the time periods in the process of performing parallax adjustment on the timeline for the stereoscopic film source, thereby improving the stereoscopic playback effect of the stereoscopic film source.

On a first aspect, an embodiment of the present disclosure provides a method for optimizing playback of a stereoscopic film source, including the following steps: acquiring a stereoscopic adjustment parameter related to a timeline of a stereoscopic film source, wherein the stereoscopic adjustment parameter includes T offset adjustments and time periods corresponding to the T offset adjustments, T being a natural number; and adjusting an offset of a frame that is in each time period when the stereoscopic film source is played in a stereoscopic mode, wherein the adjusted offset is the offset adjustment corresponding to the time period.

On a second aspect, an embodiment of the present disclosure provides a computer readable storage medium, including computer executable instructions, wherein when the computer executable instruction are executed by at least one processor, the processor executes the above method.

On a third aspect, an embodiment of the disclosure further provides an electronic device, including: at least one processor; and a memory, where the memory stores instructions that can be executed by the at least one processor, and execution of the instructions by the at least one processor causes the at least one processor to perform any of the forgoing methods for optimizing playback of a stereoscopic film source of the disclosure.

The embodiments of the present disclosure provide a method and electronic device for optimizing playback of a stereoscopic film source, wherein a stereoscopic film source is divided into T time periods on its timeline, and T corresponding offset adjustments are respectively configured for the time periods, wherein the T time periods and the T corresponding offset adjustments are stereoscopic adjustment parameters related to the timeline of the stereoscopic film source. When the stereoscopic film source is played in a stereoscopic mode, the frames played in the time periods can be adjusted by using corresponding offsets, in this way, frames of the stereoscopic film source can be adjusted by using matched adjustment parameters on the whole timeline. Different targeted stereoscopic adjustment parameters are matched according to demands of different frames to be displayed in the time periods, to ensure that the stereoscopic film source has optimal stereoscopic effects in all the time periods, and good playback effects can be achieved on different display devices, thereby achieving the objective of optimizing stereoscopic playback of the whole stereoscopic film source.

In an embodiment, the offset adjustment is a numerical value with symbol, wherein different signs represent different offset directions of left view and right view. Signs may be used to represent different offset directions of the left view and right view, so that an offset adjustment parameter is recorded briefly and clearly. In addition, in the process of adjusting frames that are played, the offset direction can be determined only according to the symbol of the offset adjustment, so that a process of stereoscopic adjustment becomes more convenient and faster.

In an embodiment, the offset adjustments each correspond to one footage in the stereoscopic film source. One film source is consisted of multiple shots, and one footage corresponds to a same offset adjustment, so as to ensure that frames of a same shot have a same display effect, thereby improving visual experience of a viewer.

In an embodiment, the step of acquiring a stereoscopic adjustment parameter related to a timeline of a stereoscopic film source includes the following substeps: breaking down the stereoscopic film source into shots to obtain frames respectively corresponding to all footages in the stereoscopic film source; selecting, from the frames respectively corresponding to all the footages in the stereoscopic film source, frames of T footages that need to be adjusted; setting an offset adjustment for each of the selected frames of the footages, and using a time period in which the frame is located in the timeline as the time period corresponding to the offset adjustment. By breaking down the stereoscopic film source, special stereoscopic optimization may be made on special part in the film, so that a process of frame adjustment becomes more particular. Therefore, in a process of playing the stereoscopic film source, frame playback effect of a particular shot can be specifically adjusted.

In an embodiment, in the step of acquiring a stereoscopic adjustment parameter related to a timeline of a stereoscopic film source, the acquired stereoscopic adjustment parameter matches a movie player of a preset type; and when the stereoscopic film source is played in a stereoscopic mode, the step of adjusting an offset of a frame that is in the time period includes the following substeps:

determining whether a movie player playing the stereoscopic film source is a movie player of the preset type; and

if the movie player is the movie player of the preset type, adjusting, by the movie player of the preset type, the offset of the frame that is in the time period, wherein the adjusted offset is the offset adjustment corresponding to the time period; or

if the movie player is not the movie player of the preset type, adjusting the offset of the frame that is in the time period, wherein the adjusted offset is a sum of the offset adjustment corresponding to the time period and a correction offset, wherein the correction offset is a view deviation of the movie player of the preset type from a movie player currently playing the stereoscopic film source, for a same frame in a same effect. The correction offset may be used for correcting a view deviation of a current movie player from the movie player of the preset type, for a same frame in a same effect, so as to resolve a problem of poor stereoscopic effect caused by different offset adjustments when the current movie player is not the preset player. That is, a same stereoscopic film source can be enabled to have good stereoscopic playback effects on different players.

In an embodiment, a corresponding relationship of offset adjustments of different movie players is preset; the correction offset is easily obtained according to the corresponding relationship, which can help reduce processing complexity of a player.

In an embodiment, the step of playing the stereoscopic film source in a stereoscopic mode further includes: receiving a press signal of a preset key; generating, according to the received press signal, an offset adjustment signal that is used for adjusting the frame being currently played. When the stereoscopic film source is played in a stereoscopic mode, users may adjust, on the basis of an existing stereoscopic effect, the stereoscopic effect according to needs on the stereoscopic frame, to satisfy the needs of different users.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a flowchart illustrating a method for optimizing playback of a stereoscopic film source according to Embodiment 1 of the present disclosure;

FIG. 2 is a schematic diagram illustrating a location relationship between left view and right view when flat panel display is applied to frames of a stereoscopic film source according to Embodiment 1 of the present disclosure;

FIG. 3 is a schematic diagram illustrating a location relationship between the left view and the right view when the frames of the stereoscopic film source are displayed in a protruding manner according to Embodiment 1 of the present disclosure;

FIG. 4 is a schematic diagram illustrating a location relationship between the left view and the right view when the frames of the stereoscopic film source are displayed in a recessing manner according to Embodiment 1 of the present disclosure;

FIG. 5 is a flowchart illustrating a method for optimizing playback of a stereoscopic film source according to Embodiment 2 of the present disclosure; and

FIG. 6 is a schematic structural diagram illustrating a stereoscopic film source playback apparatus according to Embodiment 4 of the present disclosure;

FIG. 7 is a schematic structural diagram of an electronic device according to Embodiment 6 of the present disclosure.

### DETAILED DESCRIPTION

To make the objectives, technical solutions, and advantages of the application clearer, hereinafter, the technical solutions of the application will be clearly and completely described by implementation manners with reference to the accompanying drawings in the embodiments of the disclosure. Apparently, the described embodiments are a part rather than all of the embodiments of the disclosure.

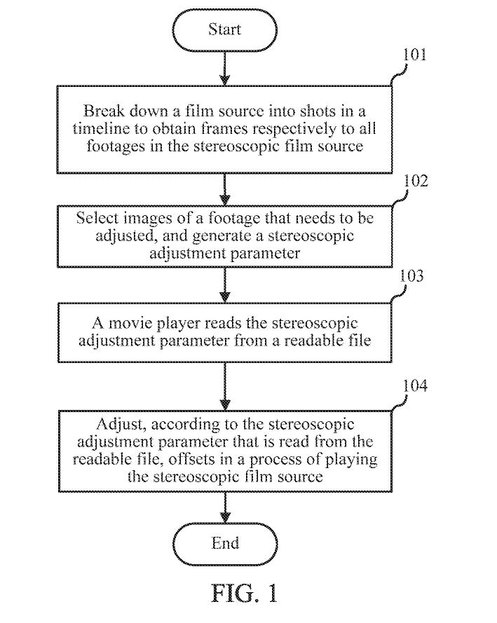

Embodiment 1 of the present disclosure relates to a method for optimizing playback of a stereoscopic film source, and the specific flow is as illustrated in FIG. 1.

In step S101, a stereoscopic film source is broken down into shots in a timeline to obtain frames respectively corresponding to all footages in the stereoscopic film source. The stereoscopic film source is broken down into shots in the timeline, so as to make preparations for subsequent acquisition of a stereoscopic adjustment parameter and offset adjustment of frames corresponding to a footage.

In step S102, frames of a footage that needs to be adjusted are selected, and a stereoscopic adjustment parameter is generated. Specially, frames of T footages that need to be adjusted are selected from the frames respectively corresponding to all the footages obtained through step S101, offset adjustment are set for the selected frames of the footages, and in combination with a time period in which the frames are located in the stereoscopic film source, stereoscopic adjustment parameters are generated, and are stored in a readable file, so as to ensure that the frames highly match the stereoscopic adjustment parameters, to ensure a high-quality stereoscopic effect.

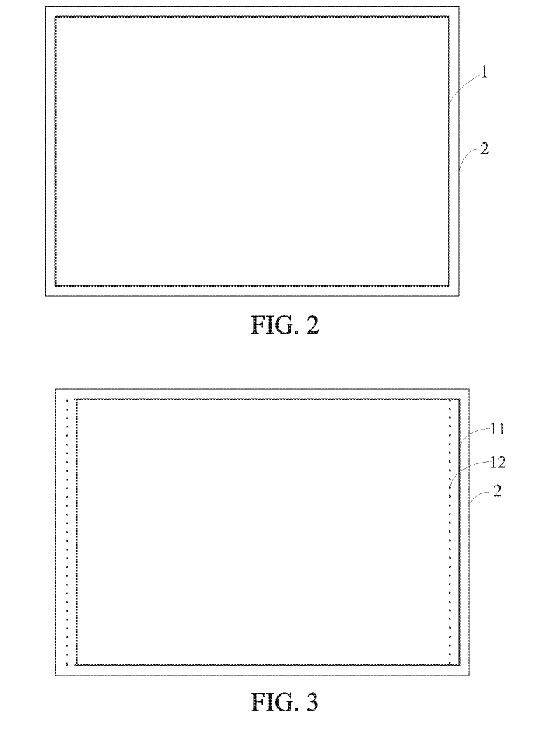

Specially, stereoscopic adjustment is generally achieved by offsetting a location of a stereoscopic image. When left view and right view of the stereoscopic film source normally and completely overlap on a screen 2, a plane effect is obtained. The relative location relationship of the left view and the right view are as illustrated in FIG. 2. In FIG. 2, a label 1 represents a frame wherein the left view and the right view completely overlap, and a label 2 represents the screen.

When the image needs to be displayed in a protruding manner as a whole, a left view 11 is translated right by N pixels, and a right view 12 is translated left by N pixels. The relative location relationship between the left view and the right view that is displayed on the screen 2 is as illustrated in FIG. 3.

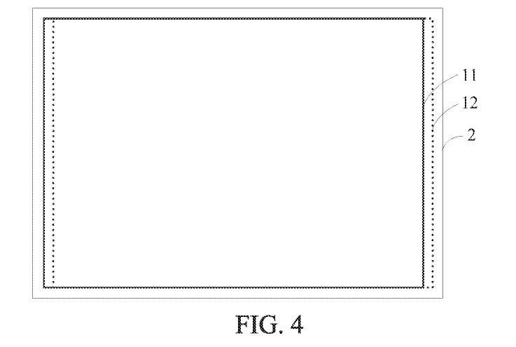

When the image needs to be displayed in a recessing manner as a whole, a left view 11 is translated left by N pixels, and a right view 12 is translated right by N pixels. The relative location relationship between the left view and the right view that is displayed on the screen 2 is as illustrated in FIG. 4.

Offset adjustments corresponding to all the time periods of the stereoscopic film source are configured by using the above offset method, and are stored as a readable file of the stereoscopic parameter related to the timeline of the stereoscopic film source. In the readable file, an offset adjustment of a time period Tᵢ is Nᵢ, and the offset adjustment Nᵢ is a numerical value with symbol. Different signs represent different offset directions of the left view and the right view. For example, Nᵢ being a positive value represents that the left view shifts towards the left by Nᵢ and the right view shifts towards the right by Nᵢ; or Nᵢ being a negative value represents that the left view shifts towards the right by |Nᵢ| and the right view shifts towards the left by |Nᵢ|. Duration of the offset adjustment Nᵢ is from the start time of the corresponding time period T, to the end time of the time period. For example, T, is from 1 to 1:30 (that is, from the first minute to the first minute and thirty seconds, and the offset adjustment of the left view and the right view is Nᵢ).

That is, in this step, several (Nᵢ, Tᵢ)s are stored in the finally obtained readable file, wherein each (Nᵢ, Tᵢ) corresponds to one footage.

In step S103, a movie player reads a stereoscopic adjustment parameter from the readable file, and acquires a start time of the time period corresponding to each offset adjustment.

In step S104, offsets in the process of playing the stereoscopic film source are adjusted according to the stereoscopic adjustment parameter that is read from the readable file. Specially, the movie player compares a current play time with the acquired start time in real time, and if the current play time is the same as the start time, searches for an offset adjustment corresponding to the time period to which the start time belongs, and adjusts an offset of a frame that is currently played according to the found offset adjustment until an end time of the time period to which the start time belongs is reached.

The movie player searches, by monitoring the time period in which a stereoscopic film is played, for an offset adjustment corresponding to the current time period, and adjust a parallax of the frames that are played in the time period, so as to ensure that the stereoscopic adjustment parameter is synchronous with the offset adjustment.

It is not difficult to find that, in this embodiment, different stereoscopic adjustment parameters are specifically matched according to needs of different frames to be displayed in all the time periods, to ensure that the stereoscopic film source has optimal stereoscopic effects in all the time periods and has good play effects on different display devices, thereby achieving the objective of optimizing stereoscopic playback of the whole stereoscopic film source. In addition, several footages are selected from the frames respectively corresponding to all the footages, and an offset adjustment is set for the selected frames of the footages, to perform special stereoscopic optimization on a special part of the film. Therefore, in a process of playing the stereoscopic film source, frame playback effect of a particular shot can be specifically adjusted.

Embodiment 2 of the present disclosure relates to a method for optimizing playback of a stereoscopic film source. This embodiment is further improved on the basis of Embodiment 1. The major improvement is that: in Embodiment 2, an acquired stereoscopic adjustment parameter matches a movie player of a preset type, that is, a preset stereoscopic adjustment parameter is aimed at a movie player of a particular type. Therefore, when a film is played, whether a movie player that actually plays the film is a movie player of the preset type (that is, whether the movie player is a movie player that matches the stereoscopic adjustment parameter) needs to be determined. If the movie player is the movie player of the preset type, an offset of a frame that is in the time period is adjusted. The adjusted offset is an offset adjustment corresponding to the time period (the same as the adjustment method in Embodiment 1). If the movie player is not the movie player of the preset type, an offset of a frame that is in the time period is adjusted. The adjusted offset is a sum of an offset adjustment corresponding to the time period and a correction offset. The correction offset is a view deviation of the movie player of the preset type from a movie player currently playing the stereoscopic film source, for a same frame in a same effect. Offsets of different movie players are corrected by using the correction offset, to resolve the problem of poor stereoscopic effects caused by different offset adjustments when a current movie player is not the preset player. That is, a same stereoscopic film source can be enabled to have good stereoscopic playback effects on different players.

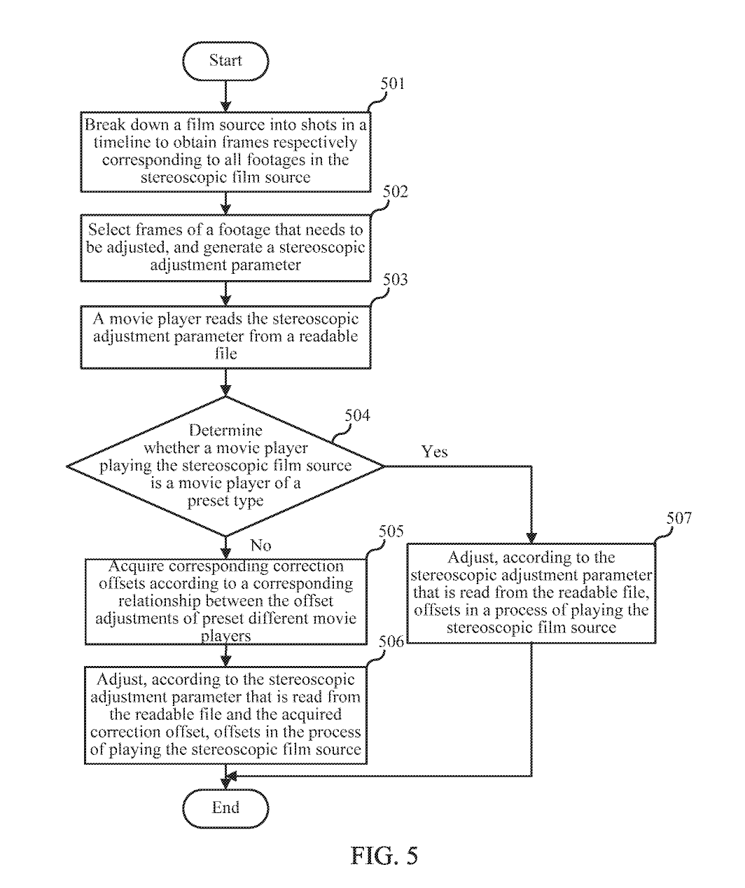

Specific flow of this embodiment is as illustrated in FIG. 5. Steps S501 to S503 are the same as steps S101 to S103 in Embodiment 1, and details are not described herein again.

In step S504, it is determined whether the movie player playing the stereoscopic film source is the movie player of the preset type, that is, it is determined whether the movie player playing the stereoscopic film source is the movie player that matches the stereoscopic adjustment parameter. Determining a type of the movie player is to make preparations for subsequent offset adjustment of an image. To achieve a stereoscopic effect that is same as the frame playback effect of the preset movie player, corresponding offset adjustment needs to be called according to the type of the movie player.

If it is determined that the movie player playing the stereoscopic film source is the movie player of the present type, the process goes to step S507, and offsets in the process of playing the stereoscopic film source may be adjusted according to the stereoscopic adjustment parameter that is read from the readable file. This step is the same as step S104, and details are not described herein again.

If it is determined that the movie player playing the stereoscopic film source is not the movie player of the present type, the process goes to step S505, and corresponding correction offsets are acquired according to a corresponding relationship between the offset adjustments of preset different movie players. For example, for a type A movie player, to achieve particular display effect, a left view and a right view need to be adjusted by an offset of Nᵢ (a symbol of Nᵢ is positive); for a type B movie player, if a same display effect needs to be achieved, the left view and the right view need to be adjusted by an offset of N′ᵢ. That is, a view deviation (that is, the correction offset) of the type A movie player from the type B movie player, for a same frame in a same effect is ↑Nᵢ-N′ᵢ|.

Subsequently, the process goes to step S506, and offsets in the process of playing the stereoscopic film source are adjusted according to the stereoscopic adjustment parameter that is read from the readable file and the acquired correction offset. After an adjustment offset of a movie player of a non-preset type is corrected, the same stereoscopic film source may have good stereoscopic effects on different players.

Embodiment 3 of the present disclosure relates to a method for optimizing playback of a stereoscopic film source. Embodiment 3 is further improved on the basis of Embodiment 1 or 2. The major improvement is that: in Embodiment 3 of the present disclosure, a preset key is added. The key can generate a press signal. A player can generate, according to a received press signal of the preset key, an offset adjustment signal that is used for adjusting a frame that is currently played, to complete adjustment of the played frame.

For example, a user may define a keyboard arrow key “↑” as positive offset adjustment, and define an arrow key “↓” as negative offset adjustment. In a process of playing a stereoscopic film source on a computer, if a user wishes that a frame shows a more recessing effect, the effect can be achieved by pressing the key “↑”. If the user wishes that the frame shows a more protruding effect, the effect can be achieved by pressing the key “↓”.

In the process of stereoscopic playback, the key is pressed to generate an offset adjustment, and a stereoscopic frame that is currently played can be adjusted again on the basis of the existing stereoscopic effect, to fit the user's visual sense, thereby improving user experience. In addition, a part in this embodiment that is the same as Embodiment 1 and methods and steps in Embodiment 1 apply to this embodiment, so details are not described herein.

The above methods are divided into steps for clear description. When the methods are achieved, the steps may be combined into one step or some steps may be divided into more steps, which shall fall within the protection scope of the present invention only if the steps include a same logic relation; the algorithm and flow to which inessential modification is made or inessential design is introduced without changing the core design of the algorithm and flow shall fall within the protection scope of the present invention.

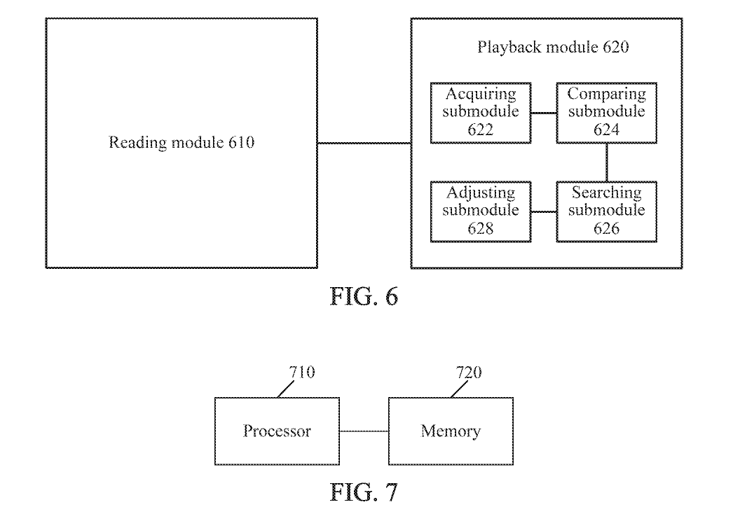

A fourth embodiment the present invention relates to a stereoscopic film source playback apparatus, which is as illustrated in FIG. 6, including:

a reading module, configured to read, from a readable file, a stereoscopic adjustment parameter related to a timeline of a stereoscopic film source, wherein the stereoscopic adjustment parameter includes T offset adjustments and time periods corresponding to the T offset adjustments, T being a natural number; and

a playback module, configured to play the stereoscopic film source, wherein when the stereoscopic film source is played in a stereoscopic mode, an offset of a frame that is in each time period is adjusted, wherein the adjusted offset is an offset adjustment corresponding to the time period.

Further, the offset adjustments each correspond to one footage in the stereoscopic film source.

In this embodiment, the playback module further includes:

an acquiring submodule, configured to acquire a start time of the time period corresponding to each of the offset adjustments;

a comparing submodule, configured to compare a current play time with the acquired start time in real time;

a searching submodule, configured to, if the current play time is the same as the start time, search for an offset adjustment corresponding to the time period to which the start time belongs; and

an adjusting submodule, configured to adjust, according to the found offset adjustment, an offset of a frame that is currently played until an end time of the time period to which the start time belongs is reached.

It is not difficult to find that this embodiment is an embodiment of an apparatus corresponding to the first embodiment, and this embodiment may be implemented in combination with the first embodiment. Related technical details described in the first embodiment are still effective in this embodiment. To reduce duplication, the technical details are not described herein again. Correspondingly, related technical details described in this embodiment may also be applied to the first embodiment.

It should be noted that modules involved in this implementation manner are logic modules. In practical application, a logical unit may be a physical unit, a part of a physical unit, or a combination of multiple physical units. In addition, to highlight innovation part of the present invention, a unit that is not closely related to the technical problem put forward in the present invention is not introduced, which do not indicate that there is no another unit in this embodiment.

Steps of the methods or algorithms that are described with reference to the embodiments revealed in the present invention may be directly embodied in hardware, a software module executed by a processor or a combination thereof. The software module may be resident in a random access memory (RAM), a flash memory, a read only memory (ROM), a programmable read only memory (PROM), an erasable read only memory (EROM), an erasable programmable read only memory (EPROM), an electrically erasable programmable read-only memory (EEPROM), a register, a hard disk, a removable disk, a compact disc read-only memory (CD-ROM) or any one form of storage medium that is known in the art. In an alternative solution, the storage medium may be integrated with the processor. The processor and the storage medium may be resident in an application-specific integrated circuit (ASIC). The ASIC may be resident in a computing apparatus or a user terminal, or, the processor and the storage medium may be resident in the computing apparatus or the user terminal as discrete components.

Embodiment 5 of the disclosure provides a non-volatile computer storage medium, which stores computer executable instructions, where the computer executable instructions can be executed to perform the method for optimizing playback of a stereoscopic film source of any of the foregoing method embodiments of the disclosure.

FIG. 7 is a schematic structural diagram of hardware of an electronic device for executing a method for optimizing playback of a stereoscopic film source provided by Embodiment 6 of the disclosure. As shown in FIG. 7, the device includes:

one or more processors 710 and a memory 720, with one processor 710 as an example in FIG. 7.

The processor 710, the memory 720 can be connected by means of a bus or in other manners, with a connection by means of a bus as an example in FIG. 7.

As a non-volatile computer readable storage medium, the memory 720 can be used to store non-volatile software programs, non-volatile computer executable programs and modules, for example, a program instruction/module corresponding to the method for optimizing playback of a stereoscopic film source in the embodiments of the disclosure (for example, a reading module 610 and a playback module 620 shown in FIG. 6). The processor 710 executes various functional applications and data processing of the server, that is, implements the method for optimizing playback of a stereoscopic film source of the foregoing method embodiments, by running the non-volatile software programs, instructions, and modules stored in the memory 720.

The memory 720 may include a program storage area and a data storage area, where the program storage area may store an operating system and at least one application needed by function; the data storage area may store data created according to use of an apparatus for optimizing playback of a stereoscopic film source, and the like. In addition, the memory 720 may include a high-speed random access memory, and also may include a non-volatile memory, such as at least one disk storage device, flash storage device, or other non-volatile solid-state storage devices. In some embodiments, the memory 720 optionally includes memories remotely disposed with respect to the processor 710, and the remote memories may be connected, via a network, to the apparatus for optimizing playback of a stereoscopic film source. Examples of the foregoing network include but are not limited to: the Internet, an intranet, a local area network, a mobile communications network, and a combination thereof.

The one or more modules are stored in the memory 720, and execute the method for optimizing playback of a stereoscopic film source in any one of the foregoing method embodiments when being executed by the one or more processors 710.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

1. A method for optimizing playback of a stereoscopic film source applied in an electronic device, comprising the following steps:
acquiring a stereoscopic adjustment parameter related to a timeline of a stereoscopic film source, wherein the stereoscopic adjustment parameter comprises T offset adjustments and time periods corresponding to the T offset adjustments, T being a natural number; and
adjusting an offset of a frame that is in the time period when the stereoscopic film source is played in a stereoscopic mode, wherein the adjusted offset is an offset adjustment corresponding to the time period.

2. The method for optimizing playback of a stereoscopic film source according to claim 1, wherein the offset adjustment is a numerical value with symbol; and
different symbols represent different offset directions of left view and right view.

3. The method for optimizing playback of a stereoscopic film source according to claim 1, wherein
the offset adjustments each correspond to one footage in the stereoscopic film source.

4. The method for optimizing playback of a stereoscopic film source according to claim 3, wherein the step of acquiring a stereoscopic adjustment parameter related to a timeline of a stereoscopic film source comprises the following substeps:
breaking down the stereoscopic film source into shots to obtain frames respectively corresponding to all the footages in the stereoscopic film source;
selecting, from the frames respectively corresponding to all the footages in the stereoscopic film source, frames of T footages that need to be adjusted; and
setting an offset adjustment for each of the selected frames of the footages, and using a time period in which the frame is located in the timeline as the time period corresponding to the offset adjustment.

5. The method for optimizing playback of a stereoscopic film source according to claim 1, wherein the step of acquiring a stereoscopic adjustment parameter related to a timeline of a stereoscopic film source further comprises storing the acquired stereoscopic adjustment parameter in a readable file;
before the step of playing the stereoscopic film source in a stereoscopic mode, the method further comprises: reading the stereoscopic adjustment parameter from the readable file; and
the step of adjusting an offset of a frame that is in the time period comprises the following substeps:
acquiring a start time of the time period corresponding to each read offset adjustment;
comparing a current play time with the acquired start time in real time;
if the current play time is the same as the start time, searching for an offset adjustment corresponding to the time period to which the start time belongs; and
adjusting an offset of a frame that is currently played according to the found offset adjustment until an end time of the time period to which the start time belongs is reached.

6. The method for optimizing playback of a stereoscopic film source according to claim 1, wherein in the step of acquiring a stereoscopic adjustment parameter related to a timeline of a stereoscopic film source, the acquired stereoscopic adjustment parameter matches a movie player of a preset type; and
when the stereoscopic film source is played in a stereoscopic mode, the step of adjusting an offset of a frame that is in the time period comprises the following substeps:
determining whether a movie player playing the stereoscopic film source is a movie player of the preset type; and
if the movie player is the movie player of the preset type, adjusting, by the movie player of the preset type, the offset of the frame that is in the time period, wherein the adjusted offset is the offset adjustment corresponding to the time period; or
if the movie player is not the movie player of the preset type, adjusting the offset of the frame that is in the time period, wherein the adjusted offset is a sum of the offset adjustment corresponding to the time period and a correction offset,
wherein the correction offset is a view deviation of the movie player of the preset type from a movie player currently playing the stereoscopic film source, for a same frame in a same effect.

7. The method for optimizing playback of a stereoscopic film source according to claim 6, further comprising:
presetting a corresponding relationship of offset adjustments of different movie players; and
acquiring the correction offset according to the corresponding relationship.

8. The method for optimizing playback of a stereoscopic film source according to claim 1, wherein the step of playing the stereoscopic film source in a stereoscopic mode further comprises:
receiving a press signal of a preset key; and
generating, according to the received press signal, an offset adjustment signal that is used for adjusting the frame being currently played.

9-11. (canceled)

12. A non-volatile computer storage medium, which stores computer executable instructions, where the computer executable instructions are configured to:
acquire a stereoscopic adjustment parameter related to a timeline of a stereoscopic film source, wherein the stereoscopic adjustment parameter comprises T offset adjustments and time periods corresponding to the T offset adjustments, T being a natural number; and
adjust an offset of a frame that is in the time period when the stereoscopic film source is played in a stereoscopic mode, wherein the adjusted offset is an offset adjustment corresponding to the time period.

13. The non-volatile computer storage medium according to claim 12, wherein the offset adjustment is a numerical value with symbol; and
different symbols represent different offset directions of left view and right view.

14. The non-volatile computer storage medium according to claim 12, wherein the offset adjustments each correspond to one footage in the stereoscopic film source.

15. The non-volatile computer storage medium according to claim 14, wherein to acquire a stereoscopic adjustment parameter related to a timeline of a stereoscopic film source, the instructions are configured to:
break down the stereoscopic film source into shots to obtain frames respectively corresponding to all the footages in the stereoscopic film source;
select, from the frames respectively corresponding to all the footages in the stereoscopic film source, frames of T footages that need to be adjusted; and
set an offset adjustment for each of the selected frames of the footages, and use a time period in which the frame is located in the timeline as the time period corresponding to the offset adjustment.

16. The non-volatile computer storage medium according to claim 12, wherein to acquire a stereoscopic adjustment parameter related to a timeline of a stereoscopic film source the instructions are configured to:
store the acquired stereoscopic adjustment parameter in a readable file;
before the step of playing the stereoscopic film source in a stereoscopic mode, the computer executable instructions are configured to: read the stereoscopic adjustment parameter from the readable file;
to adjust an offset of a frame that is in the time period the instructions are configured to:
acquire a start time of the time period corresponding to each read offset adjustment;
compare a current play time with the acquired start time in real time;
if the current play time is the same as the start time, search for an offset adjustment corresponding to the time period to which the start time belongs; and
adjust an offset of a frame that is currently played according to the found offset adjustment until an end time of the time period to which the start time belongs is reached.

17. The non-volatile computer storage medium according to claim 12, wherein to acquire a stereoscopic adjustment parameter related to a timeline of a stereoscopic film source, the acquired stereoscopic adjustment parameter matches a movie player of a preset type; and
to adjust an offset of a frame that is in the time period when the stereoscopic film source is played in a stereoscopic mode the instructions are configured to:
determine whether a movie player playing the stereoscopic film source is a movie player of the preset type;
if the movie player is the movie player of the preset type, adjust, by the movie player of the preset type, the offset of the frame that is in the time period, wherein the adjusted offset is the offset adjustment corresponding to the time period; or
if the movie player is not the movie player of the preset type, adjust the offset of the frame that is in the time period, wherein the adjusted offset is a sum of the offset adjustment corresponding to the time period and a correction offset;
wherein the correction offset is a view deviation of the movie player of the preset type from a movie player currently playing the stereoscopic film source, for a same frame in a same effect.

18. An electronic device, comprising:
at least one processor; and
a memory in communication connection with the at least one processor, where the memory stores instructions that can be executed by the at least one processor, and execution of the instructions by the at least one processor causes the at least one processor to:
acquire a stereoscopic adjustment parameter related to a timeline of a stereoscopic film source, wherein the stereoscopic adjustment parameter comprises T offset adjustments and time periods corresponding to the T offset adjustments, T being a natural number; and
adjust an offset of a frame that is in the time period when the stereoscopic film source is played in a stereoscopic mode, wherein the adjusted offset is an offset adjustment corresponding to the time period.

19. The electronic device according to claim 18, wherein the offset adjustment is a numerical value with symbol; and
different symbols represent different offset directions of left view and right view.

20. The electronic device according to claim 18, wherein the offset adjustments each correspond to one footage in the stereoscopic film source.

21. The electronic device according to claim 20, wherein to acquire a stereoscopic adjustment parameter related to a timeline of a stereoscopic film source, the at least one processor is caused to:
break down the stereoscopic film source into shots to obtain frames respectively corresponding to all the footages in the stereoscopic film source;
select, from the frames respectively corresponding to all the footages in the stereoscopic film source, frames of T footages that need to be adjusted; and
set an offset adjustment for each of the selected frames of the footages, and using a time period in which the frame is located in the timeline as the time period corresponding to the offset adjustment.

22. The electronic device according to claim 18, wherein to acquire a stereoscopic adjustment parameter related to a timeline of a stereoscopic film source the at least one processor is caused to:
store the acquired stereoscopic adjustment parameter in a readable file;
before the step of playing the stereoscopic film source in a stereoscopic mode, the computer executable instructions are configured to: read the stereoscopic adjustment parameter from the readable file;
to adjust an offset of a frame that is in the time period the at least one processor is caused to:
acquire a start time of the time period corresponding to each read offset adjustment;
compare a current play time with the acquired start time in real time;
if the current play time is the same as the start time, search for an offset adjustment corresponding to the time period to which the start time belongs; and
adjust an offset of a frame that is currently played according to the found offset adjustment until an end time of the time period to which the start time belongs is reached.

23. The electronic device according to claim 18, wherein to acquire a stereoscopic adjustment parameter related to a timeline of a stereoscopic film source, the acquired stereoscopic adjustment parameter matches a movie player of a preset type; and
to adjust an offset of a frame that is in the time period when the stereoscopic film source is played in a stereoscopic mode the at least one processor is caused to:
determine whether a movie player playing the stereoscopic film source is a movie player of the preset type;
if the movie player is the movie player of the preset type, adjust, by the movie player of the preset type, the offset of the frame that is in the time period, wherein the adjusted offset is the offset adjustment corresponding to the time period; or
if the movie player is not the movie player of the preset type, adjust the offset of the frame that is in the time period, wherein the adjusted offset is a sum of the offset adjustment corresponding to the time period and a correction offset;
wherein the correction offset is a view deviation of the movie player of the preset type from a movie player currently playing the stereoscopic film source, for a same frame in a same effect.
